(19) United States
(12) Patent Application Publication
(10) Pub. No.: US 2025/0277417 A1
(43) Pub. Date: Sep. 4, 2025

(54) BRADENHEAD PRESSURE ABATEMENT SYSTEM (BPAS) AND METHOD

(71) Applicant: Moneyhun Equipment Sales & Services Co., Inc., Rock Springs, WY (US)

(72) Inventors: John MONEYHUN, Rock Springs, WY (US); Charles WHITAKER, Rock Springs, WY (US)

(21) Appl. No.: 18/593,744

(22) Filed: Mar. 1, 2024

(51) Int. Cl. E21B 21/08; E21B 33/04; E21B 36/00

(52) U.S. Cl. CPC E21B 21/08; E21B 33/04; E21B 36/008

(57) ABSTRACT

A Bradenhead Pressure Abatement System (BPAS) comprises an enclosure to be positioned at a wellhead. An inlet valve receives bradenhead gas containing water vapor. A pair of knockout bottles receive the bradenhead gas and include an upper gas bottle coupled and a lower liquid bottle. A liquid pump is coupled to the lower bottle. An upper liquid level switch causes the inlet valve to close when liquid is sensed in the upper gas bottle. A lower liquid level switch causes the liquid pump to pump liquid from the lower bottle. A catalytic heater is coupled to the upper bottle to receive the bradenhead gas, react with the bradenhead gas and produce heat in the enclosure.

### BACKGROUND

The present invention relates generally to a bradenhead pressure abatement and gas remediation system for eliminating surface casing vent gas produced from the casing head of an oil well, or so-called casinghead or bradenhead gas.

In oil and gas wells, low-pressure and low-volume surface casing vent gas (bradenhead gas) can leak up between the casing and the cement of the well. In the past, this gas has been blown back down the well, escaped to the atmosphere, or been flared-off. Some states have increased regulatory requirements for, and many companies have specified, a safe, clean and efficient means of managing Bradenhead pressures and the ensuing fugitive gas emissions. Some states mandate that the gas pressure cannot exceed 50 psi to resist contaminating ground water.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a side view of an example Bradenhead Pressure Abatement System (BPAS) according to some embodiments, shown with a wall of an enclosure removed for visibility.

FIG. 2 is a top view of the BPAS of FIG. 1, shown with a roof of the enclosure removed for visibility.

FIG. 3 is a schematic pipe diagram of the BPAS of FIG. 1.

FIG. 4 is a schematic of the BPAS of FIG. 1.

Reference will now be made to the exemplary embodiments illustrated, and specific language will be used herein to describe the same. It will nevertheless be understood that no limitation of the scope of the invention is thereby intended.

### DETAILED DESCRIPTION

Before invention embodiments are disclosed and described, it is to be understood that no limitation to the particular structures, process steps, or materials disclosed herein is intended, but also includes equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence. Unless defined otherwise, all technical and scientific terms used herein have the same meaning as commonly understood by one of ordinary skill in the art to which this disclosure belongs.

An initial overview of the inventive concepts are provided below and then specific examples are described in further detail later. This initial summary is intended to aid readers in understanding the examples more quickly, but is not intended to identify key features or essential features of the examples, nor is it intended to limit the scope of the claimed subject matter.

A Bradenhead Pressure Abatement System (BPAS) is presented that can process bradenhead gas, fugitive gas or natural gas, from a wellhead annulus to reduce bradenhead pressure and/or remediate bradenhead gas. In addition, the BPAS can handle bradenhead gas that contains high water vapor. The BPAS can remediate or destroy bradenhead gas at rate of 6 Standard Cubic Feet per Hour (SCFH) with a catalytic heater that can react with the bradenhead gas.

The BPAS can have a controller to monitor and control the system. In addition, the BPAS and the controller can have a transceiver for remote monitoring and control. The BPAS can be electrically powered by batteries and can have a solar charging system to charge the batteries.

The catalytic heater can be supported by the bradenhead gas and a pilot gas supply, such as the wellhead. Fluid can be removed from the bradenhead gas by a pair of knockout bottles and inserted back into a flowline via a high-pressure liquid pump. The pair of knockout bottles can be vertically stacked with one over the other and interconnected.

The BPAS can have a heat trace with heated propylene glycol circulation to resist freezing in the lines supplying the system. Thus, the BPAS can have a gas system, a liquid system, and a glycol system or heat trace.

With respect to the gas system, the bradenhead gas enters the system and the enclosure from the bradenhead via a high-pressure hose into a top knockout bottle. An inlet control valve can control bradenhead gas entry into the unit and can be a primary emergency shut down (ESD) controller. A bradenhead pressure can be continuously sensed by a bradenhead gas pressure sensor and recorded by the controller. The system can have a bradenhead pressure high shut down set point of 500 psi in the controller and a gas pressure regulator set to 60 psi in the controller. The bradenhead gas and liquid or water can be separated in the pair of knockout bottles, which are interconnected by a pipe, with one over the other. The bradenhead gas can exit the top bottle and can proceed to the catalytic heater. The temperature of the heater when running can be 250° F. to 700° F. The temperature can be sensed by a catalytic heater temperature sensor and can be reported to the controller. The controller can have a heater set point for low heat shutdown of 100° F.-150° F.

With respect to the heat trace or propylene glycol system, a glycol tank can be positioned with respect to the catalytic heater to be radiantly heated. The glycol can be gravity fed to a filter and a pump to circulate the glycol. The glycol can be pumped out of the system or the enclosure to supply lines and returned to the system or enclosure. The heater can be pinned down for transport and unpinned when the system is positioned so that the heater can be selectively positioned with respect to the glycol tank to adjust the glycol temperature.

With respect to the liquid system, the bottom knockout bottle can accumulate liquid or water from the bradenhead gas. A level switch in the lower bottle can activate a high-pressure liquid pump. A level switch in the top bottle can be coupled to the controller and the inlet control valve to provide an ESD to resist liquid from entering a gas line to the catalytic heater. The liquid pump can be a dual inlet and outlet chemical injection pump capable of pumping at high pressure in order to place liquids back into the flowline. The liquid pump can be protected by a filter and a 1200 psi relief valve on an outlet to recirculate the liquid through the liquid pump when tripped.

The BPAS can also be coupled to a pilot gas source via a pilot gas inlet. A pilot gas line can have a first pressure regulator, e.g. set at 30 psi, and a three-way solenoid valve. The pilot gas line can also be coupled to the inlet control valve to supply pressure to control or open the valve. The pilot gas line can also have a second pressure regulator, e.g. set at 10 psi, and a valve, such as manual valve. The manual valve can be normally closed but can be opened to allow the second pressure regulator to control the bradenhead pressure as well as to provide pilot gas to keep the heater burning if the bradenhead gas is insufficient. Thus, the pilot gas line can also be coupled to the top knockout bottle. A valve can be coupled between the top knockout bottle and the heater to control the supply of bradenhead gas, and/or pilot gas, to the heater. The valve can also be coupled to the controller.

The bradenhead pressure can be changed by manually adjusting the second pilot gas pressure regulator and opening the manual valve. The pressure regulator can be set to 10 psi. Opening the manual valve can continuously supply the heater and/or can increase bradenhead pressure.

The BPAS and the heater can be run continuously to continuously supply gas, either bradenhead or pilot gas, to the heater. The BPAS and the heater may be run continuously when the heat trace is needed to resist supply lines from freezing. When the bradenhead pressure reaches zero, the heater may shut off without another gas source. The heater may be run at zero bradenhead pressure using the pilot gas to supply the heater. The manual valve can be opened and the pressure regulator reduced from its 10 psi default set point.

The bradenhead pressure may be adjusted if the bradenhead gas has an amount of water vapor that overwhelms the liquid pump, resulting in an emergency shut down (ESD). Increasing the pressure of the pressure regulator below a regulatory limit can results in an increased bradenhead pressure and reduce the amount of water vapor.

The inlet control valve can shut off bradenhead gas to the system and can be controlled by the controller manually or automatically if a problem arises. The three-way solenoid valve in the gas line can be a manual ESD controlled by the controller. When the three-way solenoid valve is shut, the pressure of the gas in the line to the inlet control valve can be reduced, closing the inlet control valve and closing off the bradenhead gas to the system. The inlet control valve can also offer an automated ESD if high liquid level is sensed in the top knockout bottle, or if low heater temperature is sensed at the heater indicating that it may not be lit. For example, if the level switch in the top (gas) knockout bottle senses liquid, the inlet control valve can be shut to shut off bradenhead gas to the system and resist liquid from entering into the gas line to the heater. When the inlet control valve closes, the liquid pump may continue pumping and the heater can remain lit to empty the system of liquid. When the bottles are empty, and the level sensors sense the bottles are empty, and the heater is still lit (e.g. the heater temperature sensor senses over 150° F.), the controller can automatically open the inlet control valve to resume operation.

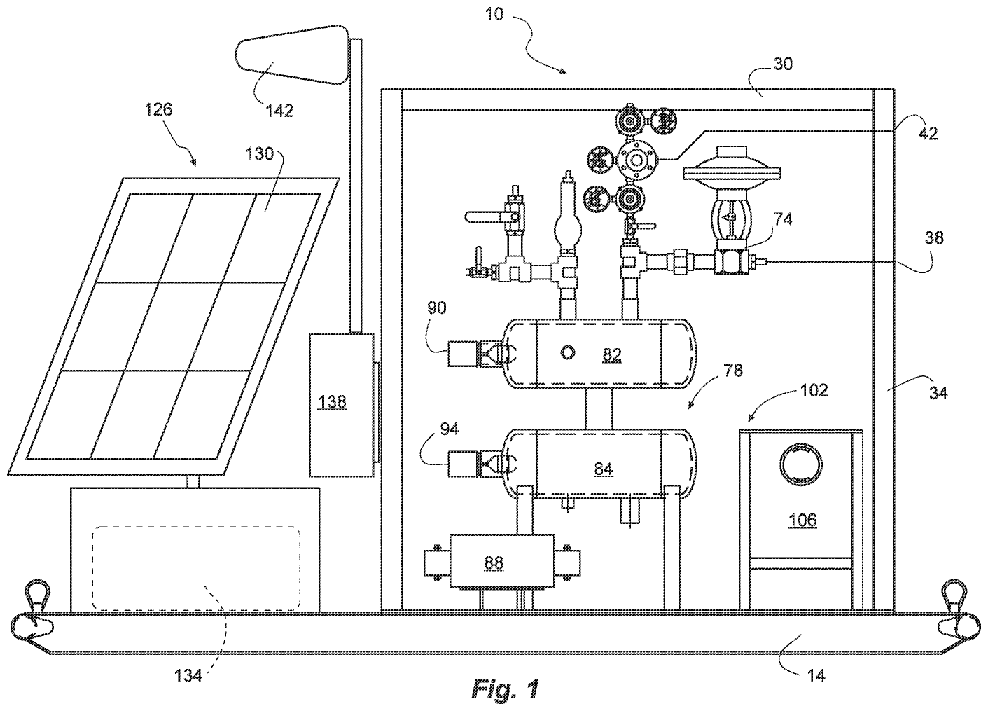

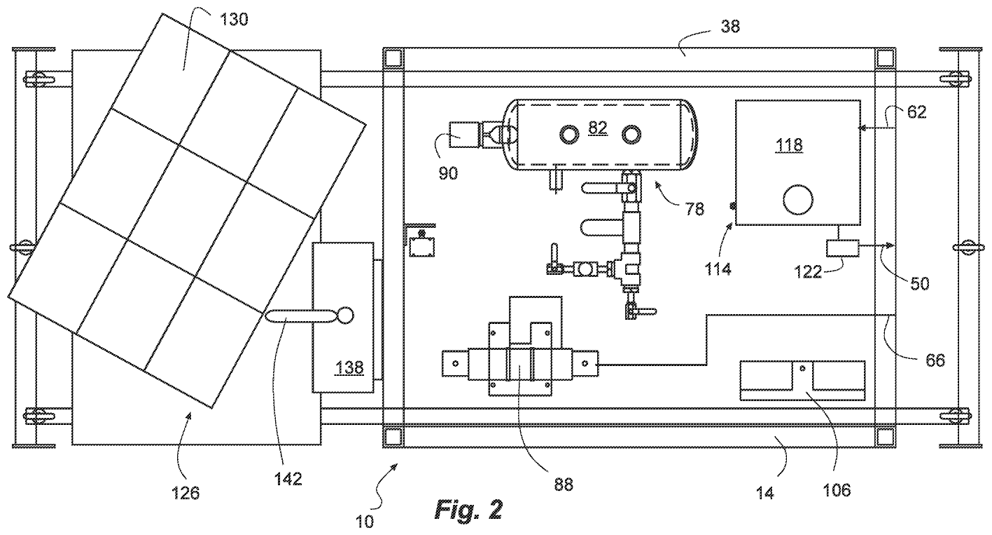

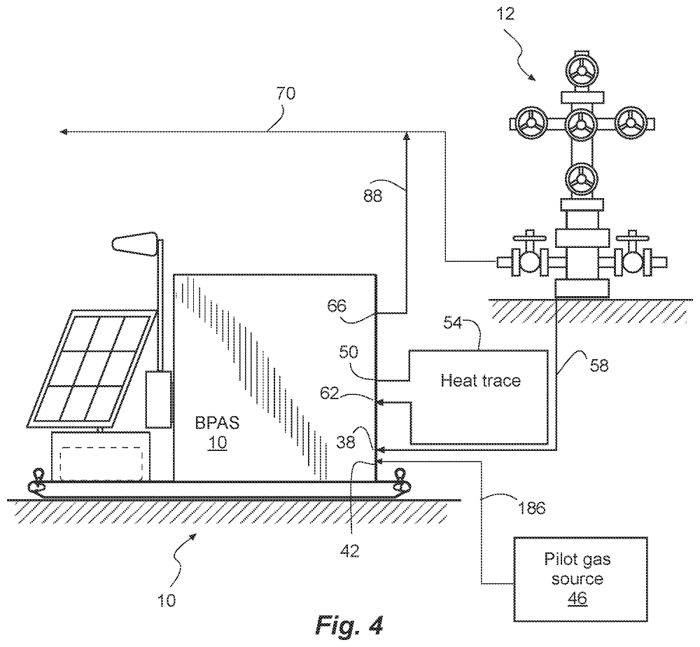

Referring to FIGS. 1-4, an example Bradenhead Pressure Abatement System (BPAS) 10 according to some embodiments is shown for reducing or abating bradenhead gas pressure and eliminating bradenhead gas with water vapor, such as from a wellhead 12 or a wellhead annulus thereof. The BPAS 10 can be substantially self-contained and mobile to be transported to a well site with the wellhead 12. The BPAS 10 can comprise a skid 14 to be positioned at the well site adjacent to the wellhead 12.

The BPAS 10 can also comprise an enclosure 18 carried by and comprising the skid 14. In one aspect, the enclosure 18 can be substantially enclosed so as to form a majority enclosure. In another aspect, the enclosure 18 can form a super-majority enclosure. The enclosure 18 can have openings therein for piping, venting, and air intake. In another aspect, the enclosure 18 can comprise a floor 26, a roof 30, and a perimeter wall 34. The floor 26 can be configured to be elevated and/or to have lower openings below the floor 26 to accommodate the forks of a forklift. In another aspect, the system 10, the enclosure 18 and the skid 14 can have eyelets to allow the system 10, the enclosure 18 and the mobile skid to be lifted with hooks, cables and a crane or loader. In addition, the roof 30 can have a vent to vent the enclosure 18. The vent and/or other vents, such as in the walls 34, can allow heat to escape and/or air (and oxygen) to enter. The system 10, the enclosure 18 and the skid 14 can be deliverable to the well site and can be located on the ground adjacent the wellhead 12. In one aspect, the skid 14 and the enclosure 18 can be sized relatively small to fit in existing wellhead sites and on trucks for transport.

The BPAS 10 and the enclosure 18 can have a plurality of ports or inlets and outlets. A bradenhead gas inlet 38 can be carried by the enclosure 18 and coupled to the wellhead 12, such as the wellhead annulus, to receive the bradenhead gas containing water vapor. A pilot gas inlet 42 can be carried by the enclosure 18 and coupled to a pilot gas source 46. The pilot gas source 46 can be the wellhead 12 or a separate source. A glycol outlet 50 can be carried by the enclosure 18 and coupled to a glycol line or heat trace line 54 associated with supply lines 58 associated with the wellhead 12 and/or the system 10. A glycol inlet 62 can be carried by the enclosure 18 and coupled to the glycol line or the heat trace line 54. A liquid outlet 66 can be carried by the enclosure 18 and coupled to a flowline 70 of the wellhead 12.

The BPAS 10 can have an inlet valve 74 or a bradenhead gas inlet valve in the enclosure 18 and coupled to the bradenhead gas inlet 38 to receive bradenhead gas containing water vapor. A liquid system 78 can be positioned in the enclosure 18. The liquid system 78 can have a pair of knockout bottles 82 and 84 interconnected and arranged vertically with one over the other to form a top or upper gas bottle 82 and a bottom or lower liquid bottle 84. The upper gas bottle 82 can be coupled to the inlet valve 74 and the bradenhead gas inlet 38 to receive the bradenhead gas with water vapor. In addition, the upper gas bottle 82 can be coupled to or selectively coupled to the pilot gas inlet 42 to receive pilot gas. The lower liquid bottle 84 can be coupled to the upper bottle 82, such as by a pipe, and can contain liquid from the water vapor in the bradenhead gas. A liquid pump 88 can be positioned in the enclosure 18 and coupled to the lower bottle 84 to pump liquid out of the lower bottle 84. In addition, the liquid pump 88 can be coupled to the liquid outlet 66 to pump the liquid out of the enclosure 18 and back to the flowline 70 of the wellhead 12.

An upper liquid level switch 90 can be associated with the upper gas bottle 82 and operatively coupled to the inlet valve 74. The inlet valve 74 can be configured to close when the upper liquid level switch 90 senses liquid in the upper gas bottle 82. A lower liquid level switch 94 can be associated with the lower bottle 84 and operatively coupled to the liquid pump 88. The liquid pump 88 can be configured to pump liquid from the lower bottle 84, out of the enclosure 18 and to the flowline 70 when the lower liquid level switch 94 senses liquid in the lower bottle 84. The liquid pump 88 can be coupled to the liquid outlet 66 carried by the enclosure 18.

A gas system 102 can be positioned in the enclosure 18. The gas system 102 can comprise a catalytic heater 106 to react with the bradenhead gas to eliminate the bradenhead gas. In addition, the catalytic heater 106 can produce heat in the enclosure, as discussed herein. The catalytic heater 106 can be coupled to the upper bottle 82, the inlet valve 74 and the bradenhead gas inlet 38 to receive the bradenhead gas. The catalytic heater 106 can be movable and selectively repositionable in the enclosure 18. The catalytic heater 106 can have at least two configurations, including a fixed configuration and a selectively positionable configuration. In the fixed configuration, the catalytic heater 106 can be removably fixed within the enclosure 18. For example, the catalytic heater can be pinned with respect to the enclosure 18 or the floor 26 thereof by a pin extending through aligned bores of the catalytic heater 106 and the enclosure 18. In the selectively positionable configuration, the catalytic heater 106 can be unpinned and movably positionable within the enclosure 18 and with respect to equipment in the enclosure, such as a glycol tank, as discussed herein.

A heat trace system 114 or propylene glycol system can be at least partially located in the enclosure 18. The heat trace system 114 or propylene glycol system can comprise a glycol tank 118 located in the enclosure 18 and configured to contain glycol. In addition, the glycol tank 118 can be positioned opposing the catalytic heater 106. The glycol tank 118 and the catalytic heater 106 can be selectively positioned with respect to one another to control a temperature of the glycol. As described herein, the catalytic heater 106 can be selectively positioned with respect to the glycol tank 118. A glycol pump 122 can be located in the enclosure 18 and coupled to the glycol tank 118. The glycol pump 122 can pump glycol heated in the glycol tank 118 out of the enclosure 18 and through a glycol line or a heat trace line 54 associated with external supply lines 58 to resist freezing, and back into the glycol tank 118. Thus, the glycol line or the heat trace line 54 can be a closed loop. The glycol pump 122 can be coupled to the glycol outlet 50 carried by the enclosure 18. The glycol tank 118 can be coupled to the glycol inlet 62 carried by the enclosure 18. The glycol line or the heat trace line 54 can be coupled to the glycol outlet 50 and the glycol inlet 62.

A solar power system 126 can be associated with the enclosure 18 to provide power even in remote locations. The solar power system 126 can comprise a solar panel 130 associated with the enclosure 18. In one aspect, the solar panel 130 can be carried by the skid 14. In another aspect, the solar panel 130 can be carried by the skid 14 during transportation to the wellsite, and mounted to the ground. A rechargeable battery 134 can be carried by the enclosure 18 or the skid 14 and coupled to the liquid pump 88 and the glycol pump 122 to provide power. Other equipment, such as electrically controlled valves, gauges and sensors, can be coupled to the battery 134 and the power system 126 as well.

A control system 138 with a controller can be carried by the skid 14 and the enclosure 18 and configured to control the system 10 and the equipment thereof. For example, the control system 138 can be coupled to the rechargeable battery 134, the inlet valve 74, and the upper liquid level switch 90. The control system 138 can also comprise a transceiver 142 configured to provide remote monitoring and control of the BPAS 10.

An inlet pressure sensor 146 can be coupled to the inlet valve 74 and the bradenhead gas inlet 38 and configured to sense inlet pressure of the bradenhead gas. The inlet pressure sensor 146 can be coupled to the control system 138. An outlet pressure sensor 150 can be coupled to an outlet of the liquid pump 88 and the liquid outlet 66 and configured to sense outlet pressure of the liquid. The outlet pressure sensor 150 can be coupled to the control system 138. A catalytic heater temperature sensor 154 can be coupled to the catalytic heater 106 and configured to sense a temperature of the catalytic heater 106. The catalytic heater temperature sensor 154 can be coupled to the control system 138. A glycol tank temperature sensor 158 can be coupled to the glycol tank 118 and configured to sense a temperature of the glycol in the tank 118. The glycol tank temperature sensor 158 can be coupled to the control system 138.

The pilot gas and the pilot gas inlet 38 can be coupled to a control side 162 of the inlet valve 74 to provide pressure to control the inlet valve 74 to control the flow of the bradenhead gas. A pilot gas valve 166, such as a solenoid valve, can be coupled in the pilot gas line 170 between the pilot gas inlet 38 and the control side 162 of the inlet valve 74 for the bradenhead gas. In addition, the pilot gas valve 166 can be coupled to the control system 138 to control pilot gas pressure to the inlet valve 73 of the bradenhead gas. Furthermore, a first pressure regulator 174 can be coupled in the pilot gas line 170 between the pilot gas inlet 38 and pilot gas valve 166.

In addition, the pilot gas and the pilot gas inlet 38 can be coupled to the upper bottle 82 and the catalytic heater 106. The pilot gas can be selectively supplied to the catalytic heater 106. For example, a valve, such as a manual valve 178 can be coupled in the pilot gas line 170 between the pilot gas inlet 38 and the upper bottle 82. In addition, a second pressure regulator 182 can be coupled in the pilot gas line 170 between the pilot gas inlet 38 and upper bottle 82. The manual valve 178 and the second pressure regulator 182 can control the bradenhead pressure by selecting the pressure at the second pressure regulator 182.

A method for reducing or abating bradenhead gas pressure and eliminating bradenhead gas with water vapor, and for using the BPAS 10 described herein, can comprise delivering or transporting the BPAS 10 to the well site with the wellhead 12. The BPAS 10 can be coupled to the wellhead 12. The bradenhead gas inlet 38, the inlet valve 74 and the upper bottle 82 can be coupled to the wellhead 12, such as coupling a bradenhead gas line, such as supply line 58, to and between the wellhead 12 and the bradenhead gas inlet 38. The pilot gas inlet 42 and the pilot gas valve 166 can be coupled to the pilot gas source 46 or the wellhead 12, such as by coupling a pilot gas line 186 to and between the pilot gas source 46 or the wellhead 112 and the pilot gas inlet 42. The liquid outlet 66 and the liquid pump 88 can be coupled to the flowline 70 of the wellhead 12, such as by coupling a liquid line 88 to and between the liquid outlet 66 and the flowline 70. The heat trace system 114, the glycol tank 118 and the glycol pump 122 can be coupled to the supply line 58 of the wellhead 12, such as by coupling the glycol line or the heat trace line 54 to the glycol inlet 62 and the glycol outlet 50. The BPAS 10 can be powered on such as by turning on the control system 138. The catalytic heater 106 can be released or unpinned and selectively positioned with respect to the glycol tank 118.

Pilot gas can be introduced to the BPAS 10 and the pilot gas line 170 through the pilot gas inlet 38. The pilot gas pressure can be regulated by the first pressure regulator 174, e.g. between 0-60 psi. The pilot gas valve 166 may be associated with the pilot gas source 46 or the wellhead 12. The pilot gas can be further pressure regulated by a third pressure regulator 190, e.g. 30 psi, and controlled by the pilot gas valve 166, e.g. a solenoid valve, and selectively introduced (by the pilot gas valve 166) to the inlet valve 74 of the bradenhead gas to provide pressure to open the inlet valve 74. The pilot gas valve 166 or the solenoid valve can be coupled to and controlled by the control system 138. The inlet valve 74 of the bradenhead gas can be coupled to and controlled by the control system 138 via the pilot gas and the pilot gas valve 166.

In addition, the pilot gas can be further pressure regulated by the second pressure regulator 182, e.g. 10 psi, and controlled by a valve, e.g. the manual valve 178, and selectively introduced (by the manual valve 178) to the upper bottle 82. In one aspect, the bradenhead gas pressure can be controlled by selectively introducing (by the manual valve 178) the pilot gas to the upper bottle 82. The pilot gas can provide a back pressure to the bradenhead gas. In another aspect, the bradenhead gas pressure can be controlled by the second pressure regulator 182 regulating the pilot gas pressure. The second pressure regulator 182 can be manually adjusted to adjust the pressure. The manual valve 178 can be opened to both control the bradenhead pressure and to continuously provide pilot gas to the catalytic heater 106. The catalytic heater 106 can be run continuously with pilot gas, even in the absence of bradenhead gas, to heat the glycol and resist freezing. Alternatively, the heater 106 can shut off when the bradenhead pressure reaches zero.

The gas, or the pilot gas and/or the bradenhead gas, can be introduced to the catalytic heater 106 from the upper bottle 82. A gas valve, such as a solenoid valve 194, can be coupled between the upper bottle 82 and the catalytic heater 106. The solenoid valve 194 can be coupled to and controlled by the control system 138. The catalytic heater 106 can be turned on by the control system 138. The control system 138 can monitor the catalytic heater 106 with the catalytic heater temperature sensor 154.

The pilot gas valve 166 can be opened by the control system 138 to supply pilot gas to the inlet valve 74 of the bradenhead gas to open the valve 74 and allow bradenhead gas into the BPAS 10 and to the upper and lower bottles 82 and 84. Water vapor can be separated from the bradenhead gas in the bottles 82 and 84 and can accumulate in the lower bottle 82. The liquid in the lower bottle 82 can be sensed by the lower liquid level switch 94 to operate the liquid pump 88. The liquid pump 88 can pump the liquid out of the lower bottle 84, out of the liquid outlet 66, through the liquid 88 line and returned to the supply line 70.

If water vapor in the bradenhead gas exceeds capacity, i.e. if liquid in the lower bottle 84 overwhelms the liquid pump 66 and accumulates in the upper bottle 82, the liquid in the upper bottle 82 can be sensed by the upper liquid level switch 90. The control system 138 can shut off pilot gas to the inlet valve 74 of the bradenhead gas by shutting the pilot gas valve 166 and removing the pilot gas pressure keeping the inlet valve 74 open; thus shutting off the inlet valve 74 and stopping the flow of bradenhead gas into the BPAS 10.

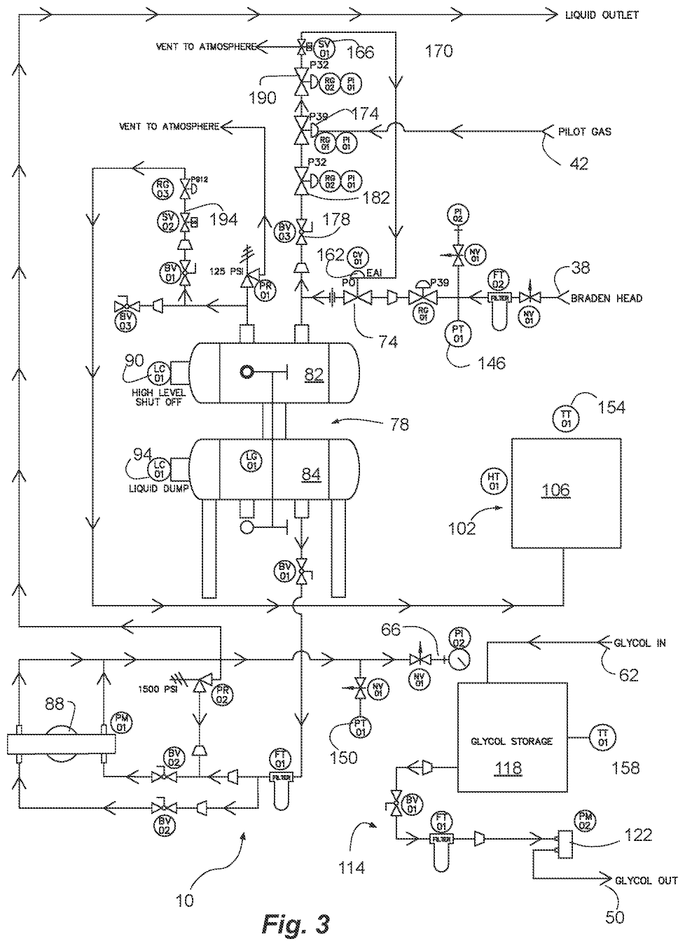

Referring to FIG. 3, various components can be identified in Table 1:

TABLE 1

| | |
|---|---|
| BV01, BV02, | Ball valve |
| BV03 | |
| NV01 | Needle valve |
| RG01, | Pressure regulator |
| RG02, RG03 | |
| PR01, PR02 | Pressure release valve |
| PI01, PI02 | Pressure gauge |
| CV01 | Control valve |
| LC01 | Electric level switch |
| LG01 | Liquid sight glass |
| FT01, FT02 | Filter |
| PM01, PM02 | Pump |
| HT01 | Heater |
| PT01 | Pressure transmitter |
| SV01, SV02 | Solenoid valve |
| TT01 | Temperature transmitter |

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in the specification, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the terms “approximately” and “about” are used interchangeably to provide flexibility to a numerical range endpoint by providing that a given value may be “a little above” or “a little below” the endpoint. It is understood that express support is intended for exact numerical values in this specification, even when the term “about” is used in connection therewith. Approximately and about refer to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

It is to be understood that the examples set forth herein are not limited to the particular structures, process steps, or materials disclosed, but are extended to equivalents thereof as would be recognized by those ordinarily skilled in the relevant arts. It should also be understood that terminology employed herein is used for the purpose of describing particular examples only and is not intended to be limiting.

Furthermore, the described features, structures, or characteristics may be combined in any suitable manner in one or more examples. In the description, numerous specific details are provided, such as examples of lengths, widths, shapes, etc., to provide a thorough understanding of the technology being described. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts described herein. Accordingly, it is not intended that the invention be limited, except as by the claims set forth below.

What is claimed is:

1. A Bradenhead Pressure Abatement System (BPAS), comprising:
a) an enclosure configured to be positioned at a wellhead;
b) an inlet valve in the enclosure and configured to receive bradenhead gas containing water vapor;
c) a pair of knockout bottles in the enclosure and comprising:
i) an upper gas bottle coupled to the inlet valve; and
ii) a lower bottle coupled to the upper gas bottle and configured to contain liquid from the water vapor in the bradenhead gas;
d) a liquid pump coupled to the lower bottle;
e) an upper liquid level switch associated with the upper gas bottle and operatively coupled to the inlet valve, the inlet valve configured to close when the upper liquid level switch senses liquid in the upper gas bottle;
f) a lower liquid level switch associated with the lower bottle and operatively coupled to the liquid pump, the liquid pump configured to pump liquid from the lower bottle, out of the enclosure and to a flowline when the lower liquid level switch senses liquid in the lower bottle; and
g) a catalytic heater coupled to the upper gas bottle and configured to receive the bradenhead gas and react with the bradenhead gas.

2. The BPAS of claim 1, further comprising a plurality of ports in the enclosure comprising:
a bradenhead gas inlet coupled to the inlet valve and configured to be coupled to a wellhead annulus to receive the bradenhead gas containing water vapor;
a pilot gas inlet coupled to the upper gas bottle; and
a liquid outlet coupled to the liquid pump.

3. The BPAS of claim 1, further comprising:
an inlet pressure sensor coupled to the inlet valve and configured to sense inlet pressure of the bradenhead gas;
an outlet pressure sensor coupled to an outlet of the liquid pump and configured to sense outlet pressure of the liquid; and
a catalytic heater temperature sensor coupled to the catalytic heater and configured to sense a temperature of the catalytic heater.

4. The BPAS of claim 1, further comprising:
a glycol tank located in the enclosure and positioned opposing the catalytic heater and configured to contain glycol;
a glycol pump located in the enclosure and coupled to the glycol tank and configured to pump glycol heated in the glycol tank out of the enclosure and through a glycol line associated with external supply lines to resist freezing; and
the catalytic heater being selectively positionable in the enclosure with respect to the glycol tank.

5. The BPAS of claim 1, further comprising:
a solar panel associated with the enclosure; and
a rechargeable battery carried by the enclosure and coupled to the liquid pump.

6. The BPAS of claim 1, further comprising:
a control system with a transceiver configured to provide remote monitoring and control of the BPAS, the control system coupled to the inlet valve and the upper liquid level switch.

7. The BPAS of claim 1, further comprising:
a pilot gas inlet coupled to the upper gas bottle and coupled to a control side of the inlet valve.

8. The BPAS of claim 1, further comprising:
the enclosure comprising a mobile skid.

9. A Bradenhead Pressure Abatement System (BPAS), comprising:
a) an enclosure configured to be positioned at a wellhead;
b) an inlet valve in the enclosure and configured to receive bradenhead gas containing water vapor;
c) a catalytic heater coupled to the inlet valve and configured to receive the bradenhead gas, react with the bradenhead gas and produce heat in the enclosure;
d) a glycol tank located in the enclosure and positioned opposing the catalytic heater and configured to contain glycol; and
e) a glycol pump located in the enclosure and coupled to the glycol tank and configured to pump glycol heated in the glycol tank out of the enclosure and through a glycol line associated with external supply lines to resist freezing.

10. The BPAS of claim 9, further comprising:
the catalytic heater being selectively positionable in the enclosure with respect to the glycol tank.

11. The BPAS of claim 9, wherein the catalytic heater has at least two configurations, including:
a fixed configuration in which the catalytic heater is removably fixed within the enclosure; and
a selectively positionable configuration in which the catalytic heater is movably positionable with respect to the glycol tank.

12. The BPAS of claim 9, further comprising:
a) a pair of knockout bottles in the enclosure and comprising:
i) an upper gas bottle coupled to the inlet valve; and
ii) a lower bottle coupled to the upper gas bottle and configured to contain liquid from the water vapor in the bradenhead gas;
b) a liquid pump coupled to the lower bottle;
c) an upper liquid level switch associated with the upper gas bottle and operatively coupled to the inlet valve, the inlet valve configured to close when the upper liquid level switch senses liquid in the upper gas bottle; and
d) a lower liquid level switch associated with the lower bottle and operatively coupled to the liquid pump, the liquid pump configured to pump liquid from the lower bottle, out of the enclosure and to a flowline when the lower liquid level switch senses liquid in the lower bottle.

13. The BPAS of claim 9, further comprising a plurality of ports in the enclosure comprising:
a bradenhead gas inlet coupled to the inlet valve and configured to be coupled to a wellhead annulus to receive the bradenhead gas containing water vapor;
a pilot gas inlet coupled to the catalytic heater;
a glycol outlet coupled to the glycol pump; and
a glycol inlet coupled to the glycol tank.

14. A Bradenhead Pressure Abatement System (BPAS) configured to process bradenhead gas containing water vapor from a wellhead to reduce bradenhead pressure, the BPAS comprising:
a) an enclosure configured to be positioned at the wellhead;
b) a bradenhead gas inlet carried by the enclosure and configured to be coupled to the wellhead annulus to receive the bradenhead gas containing water vapor;
c) an inlet valve in the enclosure and coupled to the bradenhead gas inlet;
d) a liquid system positioned in the enclosure and comprising:
i) an upper gas bottle coupled to the inlet valve;
ii) an upper liquid level switch associated with the upper gas bottle and operatively coupled to the inlet valve, the inlet valve configured to close when the upper liquid level switch senses liquid in the upper gas bottle;
iii) a lower bottle coupled to the upper gas bottle and configured to contain liquid from the water vapor in the bradenhead gas;
iv) a liquid pump coupled to the lower bottle; and
v) a lower liquid level switch associated with the lower bottle and operatively coupled to the liquid pump, the liquid pump configured to pump liquid from the lower bottle, out of the enclosure and to a flowline when the lower liquid level switch senses liquid in the lower bottle;
e) a gas system positioned in the enclosure and comprising:
i) a catalytic heater coupled to the upper gas bottle and configured to receive the bradenhead gas, react with the bradenhead gas and produce heat in the enclosure; and
ii) the catalytic heater being selectively repositionable in the enclosure;
f) a heat trace system at least partially located in the enclosure and comprising:
i) a glycol tank located in the enclosure and positioned opposing the catalytic heater and configured to contain glycol; and
ii) a glycol pump located in the enclosure and coupled to the glycol tank and configured to pump glycol heated in the glycol tank out of the enclosure and through a glycol line associated with external supply lines to resist freezing; and
g) a solar power system associated with the enclosure and comprising:
i) a solar panel associated with the enclosure; and
ii) a rechargeable battery carried by the enclosure and coupled to the liquid pump.

15. The BPAS of claim 14, further comprising a plurality of ports in the enclosure comprising:
the bradenhead gas inlet;
a pilot gas inlet coupled to the upper gas bottle;
a glycol outlet coupled to the glycol pump;
a glycol inlet coupled to the glycol tank; and
a liquid outlet coupled to the liquid pump.

16. The BPAS of claim 14, further comprising:
an inlet pressure sensor coupled to the inlet valve and configured to sense inlet pressure of the bradenhead gas;
an outlet pressure sensor coupled to an outlet of the liquid pump and configured to sense outlet pressure of the liquid;
a catalytic heater temperature sensor coupled to the catalytic heater and configured to sense a temperature of the catalytic heater; and
a glycol tank temperature sensor coupled to the glycol tank and configured to sense a temperature of the glycol in the glycol tank.

17. The BPAS of claim 14, further comprising:
a control system with transceiver configured to provide remote monitoring and control of the BPAS, the control system coupled to the rechargeable battery, the inlet valve, and the upper liquid level switch.

18. The BPAS of claim 14, wherein the catalytic heater has at least two configurations, including:
a fixed configuration in which the catalytic heater is removably fixed within the enclosure; and
a selectively positionable configuration in which the catalytic heater is movably positionable with respect to the glycol tank.

19. The BPAS of claim 14, further comprising:
a pilot gas inlet coupled to the upper gas bottle and coupled to a control side of the inlet valve.

20. The BPAS of claim 14, further comprising:
the enclosure comprising a mobile skid.
